(19) United States
(12) Patent Application Publication
(10) Pub. No.: US 2006/0143506 A1
(43) Pub. Date: Jun. 29, 2006

(54) RAID storage controller assist circuit, systems and methods

(75) Inventors: Jeffrey K. Whitt, Colorado Springs, CO (US); Andrew J. Hadley, Colorado Springs, CO (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/025,456

(22) Filed: Dec. 29, 2004

(51) Int. Cl. G06F 11/00

(52) U.S. Cl. 714/6

(57) ABSTRACT

An integrated circuit and associated methods operable therein to provide hardware assist to RAID storage management controllers. The RAID assist integrated circuit offloads a general purpose processor of the storage controller from the responsibility and processing associated with address mapping. RAID geometry and addressing parameters may be stored in a register file or similar storage associated with the RAID assist integrated circuit so as to permit logic therein to automatically map host request parameters to corresponding low level device commands and status. The RAID assist integrated circuit may incorporate scatter/gather list processing features and address mapping features. Queue management features may also be integrated therein to provide buffered queueing of commands and status exchanged between the host system and the storage controller. In addition, host interface features, storage device interface features and RAID redundancy (e.g., parity) assist features may be integrated within the RAID assist integrated circuit.

### BACKGROUND OF THE INVENTION

1. Field of the Invention

The invention relates generally to storage controllers in storage systems and more specifically relates to circuits, systems, and associated methods of operation for RAID storage management address mapping and related RAID storage management techniques.

2. Discussion of Related Art

The capacity and performance requirements for computing storage subsystems continue to grow at a rapid pace. In particular, overall performance demands on of a storage subsystem have grown in view of the rapid performance acceleration of computing systems and applications. RAID (redundant array of independent disks) storage subsystems enhance reliability through various forms of redundancy and enhance performance of the storage system by striping and other performance features that distribute stored data over multiple disk drives operating substantially in parallel.

Striping and other performance aspects of RAID storage subsystems (as well as striped, non-RAID storage subsystems) impose a processing burden on a storage controller device to map host system supplied logical addresses to corresponding physical addresses. First, a host storage I/O request typically identifies a logical volume to which the I/O request is to be directed. A logical volume may comprise portions of one or more disk drives in the storage subsystem logically treated as though they comprise a single, larger, disk drive. Redundancy information generated in accordance with RAID storage management techniques is also stored on the logical volume in a manner to enhance reliability by permitting continued operation despite the failure of a single disk drive. Thus, a first aspect of the address mapping process to be performed by a storage controller is to identify which portions of which disk drives are associated with a particular identified logical volume identified in the host systems I/O request.

Within a logical volume, a host system may address individual blocks based on a logical block address identifier. In general, a logical block address is an index value representing the offset of a particular portion/block of data from the beginning of the logical volume. Logical blocks are typically addressed by an index offset from zero through the number of blocks available in the logical volume. Since the logical volume may comprise particular portions of one or more physical disk drives, the logical block address within a logical volume must also be mapped or translated into corresponding physical locations within the affected portions of one or more disk drives of the storage system. Thus, another mapping computation is performed to determine which physical block addresses correspond to the affected logical blocks identified in the host system I/O request.

This logical to physical address mapping or translation processing can impose a significant computational burden on the storage controller of a storage subsystem. In general, storage controllers as presently practiced in the art provide a general purpose processor (“CPU”) for processing programmed instructions stored in a program memory to provide overall management of the storage subsystem. This general purpose CPU therefore performs the necessary computations for address mapping or translation between supplied logical addresses and actual physical addresses corresponding to disk drives that make up the identified logical volume.

These computations for address mapping now comprise a significant portion of the processing burden imposed on the general purpose processor (CPU) of a storage controller. As presently known in the art, a storage controller may incorporate customized integrated circuits to aid the general purpose CPU in various other aspects of storage management. For example, a custom integrated circuit is typically utilized in a storage controller, in addition to the CPU, for “front end” host interfacing to manage lower level details regarding physical and logical link protocols in communicating with attached host systems. In like manner, custom integrated circuits are typically applied to “back end” interfacing to control low level protocols and media associated with exchanges between the storage controller and attached disk drives. Still further, it is generally known in the art to provide a RAID parity computation assist integrated circuit to assist the CPU in the computations associated with generating and/or checking parity or other redundancy information associated with RAID storage management techniques.

As presently practiced in the art, it remains the under the control of the general purpose processor (CPU) to perform appropriate computations associated with mapping host requests supplied logical volume identification and logical block address identification into corresponding physical locations of the disk drives. This computational burden imposed on the general purpose processor of a storage controller has become a performance bottleneck as the performance of systems and storage devices has improved.

It is evident from the above discussion that a need exists for an improved design to improve performance of a storage controller and in particular, improve performance of a RAID storage controller as it relates to logical to physical address mapping computations.

### SUMMARY OF THE INVENTION

The present invention solves the above and other problems, thereby advancing the state of the useful arts, by providing an integrated circuit usable in conjunction with a general purpose processor of a storage controller to enhance performance of the storage controller with respect to numerous storage management processing aspects. In one aspect, the integrated circuit hereof provides computational assistance for performing logical to physical address mapping computations or translations common in RAID and other virtual storage management processing. A storage controller may receive an I/O request from an attached host system. In accordance with features and aspects hereof, the general purpose processor within the storage controller receiving the request may then simply forward the received requests substantially unchanged from the host system to the storage management assist integrated circuit embodying features and aspects hereof. No significant computation or translation of the received I/O request need be performed by the programmable general purpose CPU of the storage controller. In one aspect hereof, a programmable auxiliary memory within the storage assist integrated circuit, such as a register file, may store configuration information and other parameters useful for configuring and decoding logical address information supplied in the host I/O requests. In another aspect hereof, the integrated circuit may incorporate scatter/gather list processing features to automatically process scatter/gather list information supplied by the host I/O request. Other aspects hereof provide for integration of queues and associated queue management logic for buffering commands directed through the integrated circuit to the storage devices and for buffering status returned from the storage devices through the integrated circuit to the requesting host system. Still further integration aspects hereof may allow for incorporating host and storage device interface elements within the storage management assist integrated circuit hereof.

One feature hereof provides a storage assist circuit in a storage controller of a storage system, the circuit comprising: a storage configuration register file configured to store parameters regarding logical volumes of the storage system; and a host command processing circuit coupled to the storage configuration register file for processing received host commands in accordance with the parameters without involving any general purpose programmable processor of the storage controller.

Another aspect hereof further provides that the host command processing circuit further comprises: a device command processing circuit configured for exchanging low level commands and status with storage devices of the storage system; and an encapsulated command processing circuit communicatively coupled to the device command processing circuit for forwarding for translating the received host commands into corresponding low level commands and for exchanging the low level commands and status with the device command processing circuit.

Another aspect hereof further provides that the host command processing circuit further comprises: a command queue coupled between the encapsulated command processing circuit and the device command processing circuit for buffering low level commands generated by the encapsulated command processing circuit for further processing by the device command processing circuit.

Another aspect hereof further provides that the host command processing circuit further comprises: a completion status queue coupled between the encapsulated command processing circuit and the device command processing circuit for buffering low level status generated by the device command processing circuit for further processing by the encapsulated command processing circuit.

Another aspect hereof further provides that the host command processing circuit further comprises: a media specific physical link interface circuit coupled to the device command processor and adapted to exchange device commands and device status with storage devices in accordance with a specific media adapted for coupling storage devices to the media specific physical link interface circuit.

Another aspect hereof further provides that the storage controller is a RAID storage controller and wherein the storage configuration register file further is configured to store addressing and configuration parameters regarding a RAID logical volume.

Another feature hereof provides a method operable in a storage controller of a storage system, a method comprising: receiving an I/O request from an attached host system directed to a logical volume of the storage system; forwarding the I/O request substantially as received from a general purpose processor of the storage controller to a host command processing circuit of the storage controller; and processing the received I/O request substantially within the host command processing circuit substantially devoid of interaction with the general purpose processor.

Another aspect hereof further provides that the step of processing further comprises: indexing into a parameter table based on logical addressing information in the received I/O request to locate addressing parameters; and mapping the logical addressing information into corresponding physical addressing information based on the addressing parameters.

Another aspect hereof further provides that the step of processing further comprises: generating a low level device commands based on the physical addressing information; and queuing the generated low level device command in a device command queue for further processing.

Another aspect hereof further provides that the step of processing further comprises: unqueuing the generated low level device commands; exchanging commands and/or data with a storage device in accordance with the unqueued low level device commands; receiving completion status information regarding the exchanged commands and/or data; and queuing the completion status information in a command completion status queue.

Another aspect hereof further provides that the step of processing further comprises: unqueuing the completion status information; and returning the unqueued completion status to the attached host system.

Another feature hereof provides an integrated circuit adapted for use in a RAID storage controller, the integrated circuit comprising: RAID configuration information storage means adapted for storing addressing information relating to one or more logical volumes coupled to the storage controller; RAID geometry configuration means coupled to the RAID configuration information storage means for determining storage devices and related redundancy information associated with each logical volume coupled to the storage controller where the storage devices and redundancy information are determined in accordance with the addressing information; and logical to physical address mapping means adapted for mapping logical addressing information associated with a host system I/O request into corresponding physical addressing information for a logical volume coupled to the storage controller where the mapping is performed in accordance with the addressing information.

Another aspect hereof further provides for scatter/gather list processing means coupled to the address mapping means for processing scatter/gather list elements that describe desired exchange of data between the storage controller and a host system, wherein the scatter/gather list is passed from a host system to the integrated circuit.

Another aspect hereof further provides for queue processing means for managing queued commands and status to be exchanged between the storage controller and a host system.

Another aspect hereof further provides for command queue means coupled to the queue processing means for receiving and buffering commands from a host system to be processed by the integrated circuit; and status queue means coupled to the queue processing means for buffering status information associated with completed commands to be transferred to a host system.

Another aspect hereof further provides for host interface means for coupling the storage controller to a host system through the integrated circuit.

Another aspect hereof further provides for storage device interface means for coupling the storage controller to a storage device through the integrated circuit.

Another aspect hereof further provides for redundancy information assist means for generating and checking RAID redundancy information associated with transfers between the storage controller and attached storage devices.

### BRIEF DESCRIPTION OF THE DRAWINGS

FIG. 1 is a block diagram of an exemplary storage system having a storage system controller incorporating the storage assist integrated circuit features and aspects hereof.

FIG. 2 is a block diagram describing exemplary features and aspects hereof within the storage assist integrated circuits for processing host I/O requests.

FIGS. 3 through 5 are flowcharts describing exemplary processing of a general purpose processor in a storage controller operable in accordance with features and aspects hereof in conjunction with a storage assist integrated circuit.

FIGS. 6 through 8 are flowcharts describing exemplary processing performed within a storage assist integrated circuit in accordance with features and aspects hereof.

FIG. 9 is a block diagram depicting exemplary functional elements within an exemplary storage assist integrated circuit in accordance with features and aspects hereof.

### DETAILED DESCRIPTION OF THE DRAWINGS

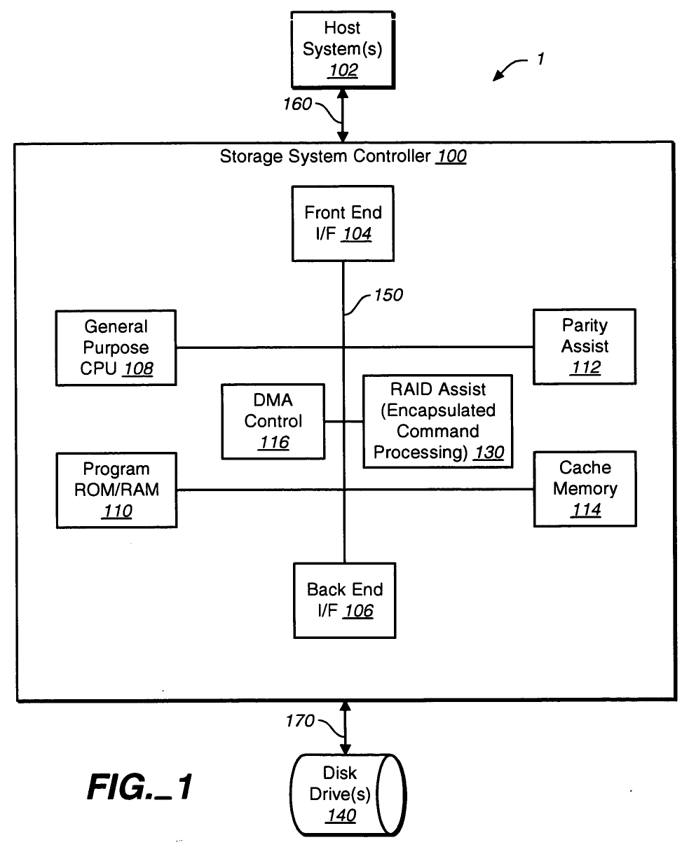

FIG. 1 is a block diagram of an exemplary system 1 wherein a storage system controller 100 manages I/O requests from attached host systems 102 for storing and retrieving information on one or more disk drives 140. Storage system controller 100 may include front-end interface element 104 for interacting with host systems 102 via communication path 160. Front-end interface element 104 may be any appropriate logic for interfacing with attached host systems 102 via appropriate protocols and media associated with communication path 160. For example, communication path 160 may utilize PCI, PCI-X, other parallel bus structures, and high speed serial interface communication paths with appropriate interface control elements 104.

Storage system controller 100 may also include back-end interface element 106 for interacting with attached disk drives 140 via communication path 170. Communication passed 170 may be Fibre Channel, parallel SCSI, other parallel bus structures, and other high speed serial communication media and protocols. Back-end interface element 106 therefore represents any of several well-known, commercially available interface elements for exchanging information over communication path 170 with attached disk drives 140.

As is the generally known in the art, storage controller may apply a general purpose CPU 108 to control overall operation of storage controller 100. General purpose CPU 108 may fetch and execute programmed instructions as well as associated variables from program ROM/RAM 110. Program ROM/RAM 110 may be any suitable memory device for storing programmed instructions and/or associated data to be executed or manipulated by CPU 108 including, for example, ROM, PROM, EPROM, flash memory, RAM, DRAM, SDRAM, etc.

Cache memory 114 is generally utilized as a buffer for storing data supplied by a host system in an I/O write request. Data to be read from, and written to, disk drives 140 may be staged in cache memory 114. DMA control element 116 may effectuate transfers among elements of the controller 100 such as: cache memory 114, front-end interface element 104, back-end interface 106 and other elements, without further burden on general purpose CPU 108. RAID parity assist element 112 may generate and check parity or other redundancy information exchanged with the disk drive 140 to further unburden the CPU 108.

In accordance with features and aspects hereof, RAID storage assist 130 provides still further acceleration assistance for removing computational the burden from general purpose CPU 108. In particular, in one aspect hereof, storage assist integrated circuit 130 may perform all necessary mapping of logical addresses into corresponding physical addresses. Thus, overall performance of storage controller 100 is further enhanced by offloading address mapping or translation computational processing from general purpose CPU 108 into dedicated custom processing circuit 130. As discussed further herein below, storage assist integrated circuit 130 may optionally also incorporate features of front-end interface element 104, back-end interface element 106, and parity assist element 112 to provide still further integration of storage management features in a single integrated circuit die package.

Those of ordinary skill in the art will recognize a wide variety of equivalent structures to that of storage system 1 of FIG. 1 to provide features and aspects hereof. In particular, numerous additional functional elements may be recognized by those of ordinary skill in the art as desirable for implementing a fully featured storage system controller 100. Still further, additional integration of components will be readily apparent where, for example, DMA control element 116 and general purpose CPU 108 may be integrated within a single microcontroller component. In addition, those of ordinary skill in the art will recognize that CPU 108 may be any of a variety of general purpose or special purpose processors adapted for overall control of storage controller 100. By contrast, storage assist integrated circuit 130 is a dedicated, application specific integrated circuit designed specifically for the purpose of enhancing storage controller performance. Whereas general purpose CPU 108 is a programmable device for which a designer programs software later compiled into programmed instructions stored in the program memory 110, storage assist integrated circuit 130 is “hardwired” for performing its broad intended purpose—namely: improving performance of commonly performed tasks within a storage system controller. Still more specifically, storage assist integrated circuit 130 may provide specific assist logic for RAID storage management including, for example, logical to physical mapping computations, scatter/gather list processing, queue management, low level storage device command generation, redundancy/parity generation/checking assistance, etc. System 1 is therefore merely intended as exemplary of one useful configuration embodying features and aspects hereof to enhance storage controller performance.

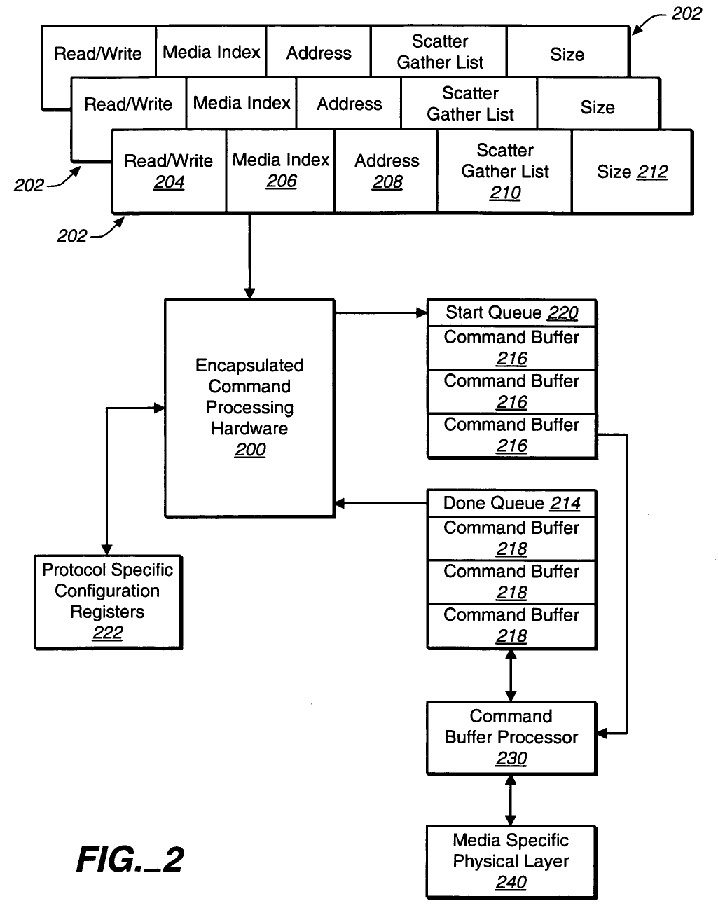

FIG. 2 is a block diagram providing additional exemplary details of processing features within storage controller assist integrated circuit 130 of FIG. 1. Storage assist integrated circuit processing receives I/O requests 202 from an attached host system. As noted above, general purpose CPU features of the storage controller perform minimal or no processing on the received I/O requests but rather forwards the information in the received request to the storage controller assist integrated circuit for further processing. Encapsulated command processing hardware 200 performs the bulk of processing within the storage controller assist integrated circuit to perform any required logical to physical address mapping and to generate low level device commands to be forwarded to the storage devices.

Each request from an attached host system may include a number of parameters and fields describing the I/O operation requested. The specific syntax and format of each I/O request record 202 is a matter of design choice well known to those of ordinary skill in the art. For example, an exemplary I/O request 202 may include a read/write field 204 indicating the direction of requested data exchange (i.e., reading from storage devices or writing to storage devices). A media index field 206 may identify a logical volume managed by the storage controller to be accessed by the I/O request. Logical address field 208 then provides logical block address offsets from the start of the identified logical volume for performing the requested I/O operation. Scatter/gather list element 210 identifies a scatter/gather list for return of the request of data or for retrieval of user data to be written to be identified logical volume. Size field 212 may identify the total size of the requested I/O operation. The particular fields discussed above as representative of an exemplary I/O request 202 are intended merely as exemplary of possible fields useful for such a purpose. Those of ordinary skill in the art will recognize a wide variety of similar, fewer, or additional fields that may be useful to permit the storage assist integrated circuit to effectively process requested I/O operations.

Encapsulated command processing hardware 200, in receipt of such an I/O request record 202, first translates the supplied logical volume and logical block address information into corresponding physical locations (i.e., physical disk drives and offset locations within the identified physical disk drives). This mapping or translation is performed in accordance with configuration and parameter information stored in register file 222. As used herein, “register file” refers to any appropriate storage locations within, or external to, the storage assist integrated circuit that identify the geometry and configuration of each logical volume known to the storage controller. Such configuration and addressing information may be initially loaded into the register file 222 by operation of the general purpose CPU associated with the storage controller during initialization of the storage subsystem.

In addition to address translation processing, encapsulated command processing hardware 200 generates and queues one or more low level storage device commands required to perform the requested I/O operation. The generated commands may each be stored in a command buffer 216 and each command buffer 216 may be entered in command queue 220. The command queue 220 may be implemented as a simple FIFO, as a register file, or as any other suitable memory component within, or external to, the storage controller assist integrated circuit.

Command buffer processor 230 within the storage assist integrated circuit may then asynchronously unqueue a next command buffer 216 identifying a low level command to be executed next and may then perform/exchange the identified low level command with the identified storage device. Media specific physical layer element 240 within storage assist integrated circuit (or external thereto) may then transfer the low level command to the identified storage device. Upon completion of the transferred low level storage device command, media specific physical layer element 240 may return a completion status to command buffer processor 230 which, in turn, may queue the returned status in the done queue 214. Each returned status may be represented in the queue by the corresponding buffer 218. Encapsulated command processing hardware 200 may then receive the buffered return status and forward the returned status to the requesting host system.

By contrast to storage control systems devoid of the storage assist integrated circuit features and aspects hereof, the present storage controller's features and aspects provide substantial processing in a customized, application specific integrated circuit as compared to a general purpose (or special purpose) processor executing programmed instructions to perform similar processing features. As noted above, processing features performed within encapsulated command processing hardware may include logical to physical address translation, scatter/gather list processing to manipulate the data forwarded to, or returned from, the storage devices, queue management processing to queue low level devices device commands and to unqueue returned status information, and other processing features.

Those of ordinary skill in the art will recognize a wide variety of similar architectures and configurations to provide features and aspects hereof to enhance performance of a storage controller by offloading storage management tasks into a dedicated, application specific, integrated circuit. In particular, RAID storage management features may be so offloaded from a general purpose CPU of the storage controller by providing a RAID storage controller insist integrated circuit.

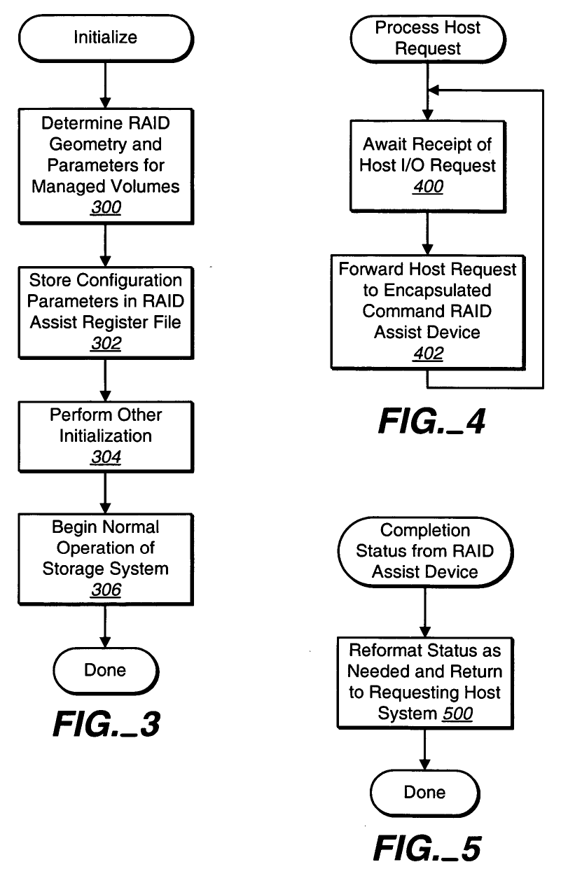

FIGS. 3 through 5 are flowcharts representing the simplified processing performed in a general purpose CPU of a storage controller enhanced in accordance with features and aspects hereof to incorporate a storage controller assist integrated circuit. Specifically, FIG. 3 represents a flow chart describing initialization processing performed by the general purpose CPU of a storage controller enhanced in accordance with features and aspects hereof. Element 300 is first operable to determine RAID geometry and parameter information for all logical volumes known to the storage controller. Such information may be determined directly by user input in initialization, may be supplied by an attached host system, may be stored in, and retrieved from reserved locations on the storage devices, or other well-known techniques for determining or deriving the logical volume configuration and parameter information.

The geometry and parameter information so determined by element 300 is then stored in a register file associated with the storage controller assist integrated circuit. As noted above, the register file may be implemented as a plurality of registers, as an internal RAM memory device, or any other suitable memory structure for recording configuration and parameter information regarding logical volumes known to the storage controller. Once such configuration and parameter information is stored in the register file of the storage assist integrated circuit, the general purpose CPU will no longer be required to perform numerous, computationally intensive functions to complete processing of attached host I/O requests. Element 304 is then operable to perform other standard initialization required by the storage controller and element 306 then commences normal operation of the storage system.

FIG. 4 is a companion flowchart describing normal I/O processing within the storage controller enhanced in accordance with features and aspects hereof. Element 400 is operable to await receipt of a next I/O request from an attached host system. Upon receipt of such a request, element 402 is operable to transfer or forward the received request to the storage assist integrated circuit for further processing. The I/O request is forwarded or transferred to the storage assist integrated circuit in substantially the same form it is received from the attached host. In other words, the general purpose CPU of the storage controller need not perform significant processing to translate logical addresses supplied with the host systems I/O request nor perform any substantial processing associated with generating and executing low level device commands to perform the received I/O request. Upon forwarding the host request to the storage assist integrated circuit, processing continues by looping back to element 400 to await receipt of a next I/O request.

FIG. 5 represents exemplary processing of a storage controller enhanced in accordance with features and aspects hereof operable in response to receipt of a completion status for an I/O request previously forwarded or transferred to the storage assist integrated circuit. Element 500 is operable to reformat the returned status as needed (if at all) and to then return the reformatted status to the corresponding requesting host system.

Key to the processes shown in FIGS. 3 through 5 is the fact that the general purpose CPU performing the described methods entails vastly simplified processing as compared to presently known storage controller structures and methods. By contrast, presently known storage controllers burden the general purpose CPU with numerous features specific to RAID or other storage management including, for example, logical to physical memory location address mapping, low level device command generation, and other features. Numerous equivalent methods will be readily apparent to those of ordinary skill in the art for providing similar features and aspects.

Those of ordinary skill in the art will readily recognize that the flowcharts of FIGS. 3 through 5 are intended as merely suggestive of typical processing within a CPU of a storage controller enhanced with a storage assist integrated circuit in accordance with features and aspects hereof. Numerous equivalent processes will be readily apparent to those of ordinary skill of the art.

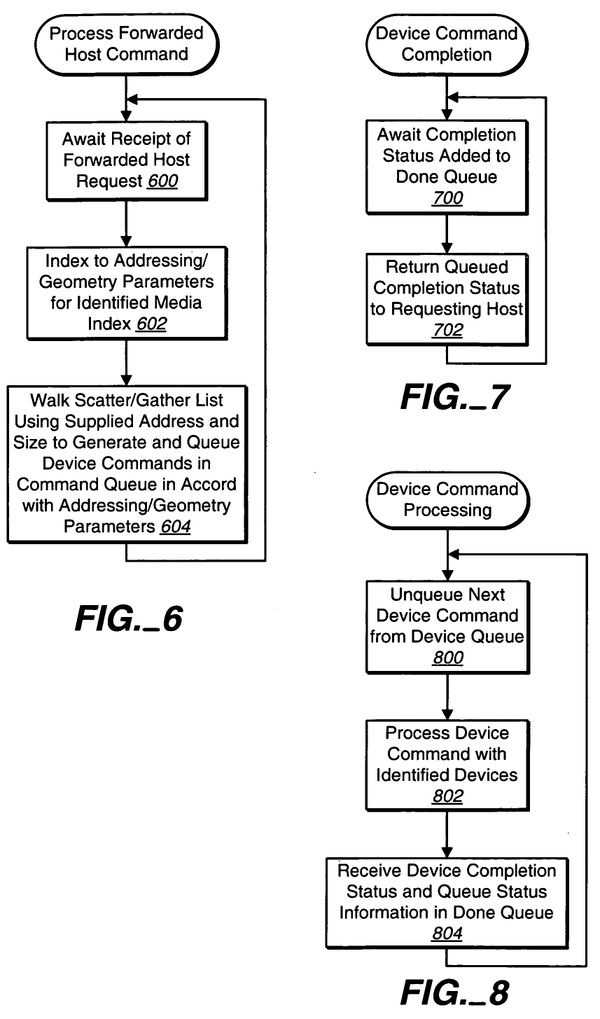

FIGS. 6 through 8 are flowcharts describing exemplary processing within a storage assist integrated circuit in accordance with features and aspects hereof. FIG. 6 is a flowchart describing processing within the storage assist integrated circuit responsive to receipt of an I/O request forwarded or transferred to the storage system controller. Element 600 is first operable to await receipt of a forwarded or transferred I/O request from the controller's CPU. Upon receipt of such a host request, element 602 is operable to index to an addressing/geometry parameter table entry corresponding to the identified media or logical volume. The indexing operation may be a simple arithmetic operation to add an offset to a base address for the configuration table information base address for the logical volume being accessed. Those of ordinary skill will recognize numerous well known techniques to locate addressing geometry and parameter information for a particular logical volume.

Using the addressing and geometry information located by operation of element 602, element 604 is then operable to “walk” the scatter/gather list supplied by the host system in the receiver I/O request record. Typical structures for scatter/gather lists and for processing of such lists are well known to those of ordinary skill in the art. Prior systems typically perform such “walking” of scatter/gather lists by operation of programmed instructions in the general purpose CPU associated with the storage controller. By contrast, the storage assist integrated circuit features and aspects hereof provide hardware assist logic to offload such processing to from the general purpose CPU. As the scatter/gather list elements are encountered, the address information, translated from logical addressing into physical addressing, is used to generate and queue appropriate low level device commands to perform the requested I/O operation. The addressing and geometry information located by element 602 is applied to identify particular locations on particular disk drives of the storage system to be manipulated in performing the requested I/O operation.

The generated low level device commands are entered into an appropriate device queue associated with the storage assist integrated circuit. Such a queue may be implemented, as noted above, utilizing well-known FIFO circuit elements, register file circuit elements, RAM memory components, or any other suitable memory device for storing queued low level device commands. Still further, management logic for such a queue may be integrated within the storage assist integrated circuit to further offload processing from the general purpose CPU of the storage controller.

Having so generated and queued appropriate low level device commands to perform the requested I/O operation, processing of the flowchart a FIG. 6 continues looping back to element 602 await receipt of another forwarded or transferred host request.

FIG. 7 is a flowchart describing exemplary processing within a storage assist integrated circuit in accordance with features and aspects hereof in response to receiving indicia of a completed status available from performance of a previously queued low level device command. The device command completion processing of the storage assist integrated circuit is operable at element 700 to await completion status returned from the low level command processing. As above, the returned status may be entered into a queue implemented within the storage assist integrated circuit in the form of a FIFO, a register file, RAM memory element, or other suitable memory structures for storing queued completion status. Further, queue management logic may be implemented within the storage assist integrated circuit to further offload processing of the general purpose CPU for such features. When element 700 senses a completed status in the done queue, element 702 is then operable to unqueue the completion status and return the unqueued completion status to the requesting host system. Processing of the method of FIG. 7 then continues looping back to element 700 to await detection of a next completion status added to the done queue.

FIG. 8 is a flowchart describing exemplary low level storage device command processing implemented within a storage assist integrated circuit in accordance with features and aspects hereof. As noted above, low level commands are preferably buffered or queued in a device command queue by operation of other processing within the storage assist integrated circuit. Element 800 is therefore operable to unqueue a next generated low level device command from the device command queue. Element 802 then processes the unqueued device command by applying the command to appropriate identified storage devices and awaiting the completion status thereto. Element 804 is operable to receive the completion status of the processed device command and to queue the completion status information in the command done queue noted above. Also as noted above, queue processing relating to elements 800 through 804 of FIG. 8 may be integrated within the storage assist integrated circuit in accordance with features and aspects hereof.

Those of ordinary skill in the art will readily recognize that the flowcharts of FIGS. 6 through 8 are intended as merely suggestive of typical processing within a storage assist integrated circuit in accordance with features and aspects hereof. Numerous equivalent processes will be readily apparent to those of ordinary skill of the art.

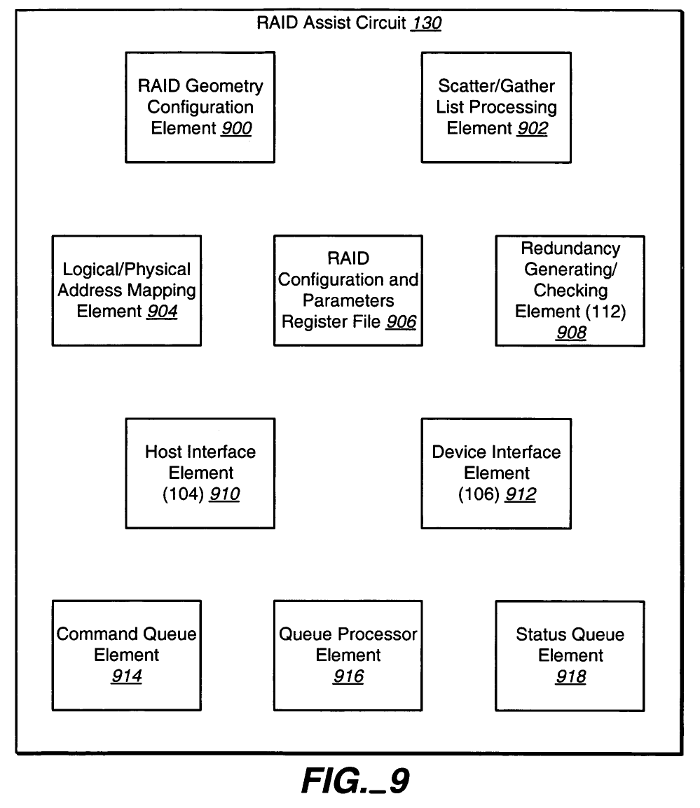

FIG. 9 is a block diagram depicting a number of typical functional elements that may be implemented within a storage assist integrated circuit such as circuit 130 of FIG. 1. Storage assist integrated circuit 130 of FIG. 9 may include RAID geometry configuration processing element 900 scatter/gather list processing element 902. RAID geometry configuration element 900 is operable to determine configuration and parameter information relating to logical volumes known to the storage controller. Using such information, regardless of the source, geometry configuration element 900 is operable to store the determined configuration in parameter information register file 906. As noted above, the configuration and parameters register file 906 may be implemented as a register file or any other suitable memory structure for storing configuration and parameter information regarding each logical volume known to the storage controller. Logical to physical address mapping element 904 may then utilize the configuration and parameter information stored in register file 906 for translating or mapping supplied logical addresses into corresponding physical address information. Scatter/gather list processing element 902 may then traverse or walk through a supplied scatter/gather list supplied in a received host request to identify particular sequences of low level device commands to be generated and executed.

Queue processor element 916 may be integrated within the storage assist integrated circuit to manage queue processing for the command queue element 914 and status or done queue element 918. In general, queue processing element 916 may add low level device commands generated by scatter/gather list processing element 902 into the command queue element 914 and may add device completion status information generated by the storage device and received through the device interface element 912 into the status or done queue element 918. Queue processing element 906 may also unqueue elements from either queue to forward a generated command to the device interface element 912 or to return a queued completion status to the host through host interface element 910.

As noted above, other performance enhancement storage management features may be incorporated within the storage assist integrated circuit 130 as a matter of design choice. For example, host interface element 910 (104 of FIG. 1) may be integrated within the storage assist integrated circuit 130 or may be a separate component in the storage controller design. In like manner, device interface element 912 (106 of FIG. 1) and redundancy generating or checking element 908 (112 of FIG. 1) may also be integrated within storage assist integrated circuit 130.

Those of ordinary skill in the art will readily recognize that the block diagram of FIG. 9 is intended merely as exemplary of typical functional elements that may be integrated within a storage assist integrated circuit in accordance with features and aspects hereof. Numerous other features may be similarly integrated within the integrated circuit. Further, other functional elements shown in FIG. 9 may be removed or combined to provide equivalent functionality.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A storage assist circuit in a storage controller of a storage system, the circuit comprising:
a storage configuration register file configured to store parameters regarding logical volumes of the storage system; and
a host command processing circuit coupled to the storage configuration register file for processing received host commands in accordance with the parameters without involving any general purpose programmable processor of the storage controller.

2. The circuit of claim 1 wherein the host command processing circuit further comprises:
a device command processing circuit configured for exchanging low level commands and status with storage devices of the storage system; and
an encapsulated command processing circuit communicatively coupled to the device command processing circuit for forwarding for translating the received host commands into corresponding low level commands and for exchanging the low level commands and status with the device command processing circuit.

3. The circuit of claim 2 wherein the host command processing circuit further comprises:
a command queue coupled between the encapsulated command processing circuit and the device command processing circuit for buffering low level commands generated by the encapsulated command processing circuit for further processing by the device command processing circuit.

4. The circuit of claim 3 wherein the host command processing circuit further comprises:
a completion status queue coupled between the encapsulated command processing circuit and the device command processing circuit for buffering low level status generated by the device command processing circuit for further processing by the encapsulated command processing circuit.

5. The circuit of claim 2 wherein the host command processing circuit further comprises:
a media specific physical link interface circuit coupled to the device command processor and adapted to exchange device commands and device status with storage devices in accordance with a specific media adapted for coupling storage devices to the media specific physical link interface circuit.

6. The circuit of claim 1 wherein the storage controller is a RAID storage controller and wherein the storage configuration register file further is configured to store addressing and configuration parameters regarding a RAID logical volume.

7. In a storage controller of a storage system, a method comprising:
receiving an I/O request from an attached host system directed to a logical volume of the storage system;
forwarding the I/O request substantially as received from a general purpose processor of the storage controller to a host command processing circuit of the storage controller; and
processing the received I/O request substantially within the host command processing circuit substantially devoid of interaction with the general purpose processor.

8. The method of claim 7 wherein the step of processing further comprises:
indexing into a parameter table based on logical addressing information in the received I/O request to locate addressing parameters; and
mapping the logical addressing information into corresponding physical addressing information based on the addressing parameters.

9. The method of claim 8 wherein the step of processing further comprises:
generating a low level device commands based on the physical addressing information; and
queueing the generated low level device command in a device command queue for further processing.

10. The method of claim 9 wherein the step of processing further comprises:
unqueueing the generated low level device commands;
exchanging commands and/or data with a storage device in accordance with the unqueued low level device commands;
receiving completion status information regarding the exchanged commands and/or data; and
queueing the completion status information in a command completion status queue.

11. The method of claim 10 wherein the step of processing further comprises:
unqueueing the completion status information; and
returning the unqueued completion status to the attached host system.

12. An integrated circuit adapted for use in a RAID storage controller, the integrated circuit comprising:
RAID configuration information storage means adapted for storing addressing information relating to one or more logical volumes coupled to the storage controller;
RAID geometry configuration means coupled to the RAID configuration information storage means for determining storage devices and related redundancy information associated with each logical volume coupled to the storage controller where the storage devices and redundancy information are determined in accordance with the addressing information; and
logical to physical address mapping means adapted for mapping logical addressing information associated with a host system I/O request into corresponding physical addressing information for a logical volume coupled to the storage controller where the mapping is performed in accordance with the addressing information.

13. The integrated circuit of claim 12 further comprising:
scatter/gather list processing means coupled to the address mapping means for processing scatter/gather list elements that describe desired exchange of data between the storage controller and a host system, wherein the scatter/gather list is passed from a host system to the integrated circuit.

14. The integrated circuit of claim 12 further comprising:
queue processing means for managing queued commands and status to be exchanged between the storage controller and a host system.

15. The integrated circuit of claim 14 further comprising:
command queue means coupled to the queue processing means for receiving and buffering commands from a host system to be processed by the integrated circuit; and
status queue means coupled to the queue processing means for buffering status information associated with completed commands to be transferred to a host system.

16. The integrated circuit of claim 12 further comprising:
host interface means for coupling the storage controller to a host system through the integrated circuit.

17. The integrated circuit of claim 12 further comprising:
storage device interface means for coupling the storage controller to a storage device through the integrated circuit.

18. The integrated circuit of claim 12 further comprising:
redundancy information assist means for generating and checking RAID redundancy information associated with transfers between the storage controller and attached storage devices.
